(19) United States
(12) Patent Application Publication
(10) Pub. No.: US 2020/0242684 A1
(43) Pub. Date: Jul. 30, 2020

(54) ITEM RESALE MANAGEMENT

(71) Applicant: Mercari, Inc., Palo Alto, CA (US)

(72) Inventors: Koichi MIYAMAE, Tokyo (JP); Minami OKI, Tokyo (JP)

(73) Assignee: Mercari, Inc., Palo Alto, CA (US)

(21) Appl. No.: 16/259,097

(22) Filed: Jan. 28, 2019

(51) Int. Cl. G06Q 30/06; G06Q 30/02

(52) U.S. Cl. CPC G06Q 30/0641; G06Q 30/0222; G06Q 30/0633; G06Q 30/0627

(57) ABSTRACT

In one example embodiment, a data processing apparatus includes a database that stores purchase history information; and a processor that causes a user device to display a list of at least one purchased item and a selectable re-sell button to re-sell each purchased item. The processor provides the selectable re-sell button after a certain period of time, based on predetermined criteria, from time of the purchase of the at least one item. When the selectable re-sell button is selected, the processor provides the user device with a user interface to input information about the purchased item, and the user interface includes multiple input fields of which at least one of the multiple input fields is suggested by the processor based on the purchase history information stored in the database.

### TECHNICAL FIELD

The present disclosure relates to technologies for managing a re-sale of an item.

### BACKGROUND

Online trading of second-hand items has been brisk in recent years. As part of this trend, various online systems for supporting the trading of second-hand items have been developed through which many users purchase, sell, and even re-sell second-hand items. In order to energize these online trading systems, technical support to facilitate such re-sale is needed.

### SUMMARY

In one example embodiment, a data processing apparatus for managing a re-sale of an item includes a database that stores purchase history information of an item purchased from an online marketplace; and a processor that causes a user device to display a list of at least one purchased item and a selectable button to re-sell each purchased item. The processor provides the selectable re-sell button after a certain period of time, based on predetermined criteria, from time of a purchase of the corresponding item, and when the selectable re-sell button is selected, the processor provides the user device with a user interface to input information about the purchased item. The user interface includes multiple input fields of which at least one of the multiple input fields is suggested by the processor based on the purchase history information stored in the database.

The purchase history information may include a category of the item, and the predetermined criteria are relevant to the category.

The purchase history information may include at least one of a name, category, brand, size, hashtag, shipping charge information for the item, a date of purchase of the item, condition of the item at the time of the purchase, a history of at least one time of previous sale of the item or a price history thereof.

The processor may post the information input into the user interface on the online marketplace, where the information may include the date of purchase and the condition of the item at the time of the purchase when posting the information.

The processor may post the information input into the user interface on the online marketplace, and may provide the history of at least one time of previous sale of the item and the price history thereof when posting the information.

The processor may provide a history of previous sales of the item and a price history thereof in the form of a graph.

The processor may count the number of re-sale postings of the at least one purchased item.

If the number of times of re-sale reaches a predetermined number, the processor may cause the display of an incentive available on the online marketplace to the user device.

If the number of re-sales does not reach the predetermined number, the processor may calculate a difference between the number of times of re-sale and the predetermined number of times, and may provide the user device with a notice of the difference.

In another example embodiment, a method to be implemented on a computer, includes causing the display of a list of items purchased from an online marketplace; determining whether a predetermined amount of time has lapsed since the purchase of the items; causing the display of a selectable re-sell button for each purchased item if it is determined that the predetermined amount of time has lapsed; and causing the display of a user interface to input information regarding the purchased item when the re-sell button is selected. The user interface includes multiple input fields and at least one of the multiple input fields is suggested based on the purchase history information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only, since various changes and modifications will become apparent to those skilled in the art from the following detailed description. The use of the same reference numbers in different figures indicates similar or identical items.

FIG. 1 is an example depiction of a system by which item re-sale management may be implemented, in accordance with various embodiments.

FIG. 2 is an example screenshot on a user device of an online marketplace, in accordance with various embodiments.

FIG. 3A is another example of a screen displayed when a “Buying” button is selected on the screen of FIG. 2, in accordance with various embodiments.

FIG. 3B is yet another example screenshot, in accordance with various embodiments, when a “Buying” button is selected on the screen of FIG. 2.

FIG. 4 shows a table to illustrate examples of when a “Sell” button may be displayed, at different points in time depending on category information, in accordance with various embodiments.

FIG. 5A is a screenshot on a user device that may appear when selling an item through an online marketplace, in accordance with various embodiments.

FIG. 5B is another screenshot on a user device that may appear, in accordance with various embodiments, when selling an item through an online marketplace.

FIG. 6 shows a table to illustrate examples of data input into a user interface, in accordance with various embodiments.

FIG. 7 shows screenshots to illustrate an example data flow between respective screens on a device, in accordance with various embodiments.

FIG. 8A is an example screenshot on a user device shown upon a re-sale posting in the online marketplace, in accordance with various embodiments.

FIG. 8B is an example screenshot showing an incentive displayed to the user, in accordance with various embodiments.

FIG. 8C is an example screenshot showing a pre-notification of an incentive to the user, in accordance with various embodiments.

FIG. 9 shows a table to illustrate examples of when an incentive may be offered, in accordance with various embodiments.

FIG. 10 shows a table to illustrate examples of incentives that may be offered, in accordance with various embodiments.

FIG. 11 is an example screenshot of posted item information, in accordance with various embodiments.

FIG. 12 shows an example graph of sale and price history, in accordance with various embodiments.

FIG. 13 is an example processing flow for supporting the re-sale of an items, in accordance with various embodiments.

FIG. 14 is an example computer system useful for implementing various embodiments.

### DETAILED DESCRIPTION

Technologies for supporting the re-sale of an item are described herein. System, apparatus, method, and computer program product embodiments may be configured to enable a user to easily resell items purchased from an online marketplace without having to re-input pre-stored information about the items. According to at least one embodiment described herein, a data processing apparatus may automatically adjust the time available for the user to resell his/her purchased items; and according to at least one other embodiment, an incentive may be offered depending on the number of re-sales, to promote the re-sale of an item, and thus energize the online marketplace.

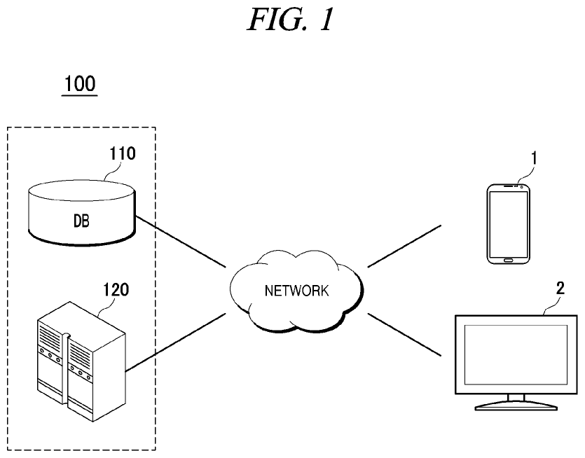

FIG. 1 is an example depiction by which item re-sale management may be implemented, in accordance with various embodiments described herein. As depicted in FIG. 1, the apparatus 100 for implementing item re-sale management includes, at least, a database 110 and a processor 120. The database 110 and the processor 120 communicate with user device 1 or user PC 2 through a network, and database 110 and processor 120 may also communicate with each other through the network, which may be a wired or wireless network or a combination thereof.

User device 1 may be a mobile device (smartphone, tablet, smart watch, etc.) and user PC 2 may be a personal computer (PC, laptop, etc.). Alternatively, either user device 1 or user PC 2 may be a mobile device or a PC. It is noted that user device 1 and user PC 2 are not limited to these examples, and may be any electronic device as will be appreciated by persons skilled in the relevant art(s).

The database 110 may store purchase history information for an item purchased by a user from an online marketplace. The purchase history information may include at least a name, category, brand, size, hashtag, and/or shipping charge of the item. The purchase history information may be input into a management system for the online marketplace by a seller of the item when the user purchases the item. Further, the purchase history information may include the date of purchase of the item by the user, the condition of the item at the time of the purchase, as well as sale and price history of the item in the online marketplace before a user purchases the item.

As described above, the processor 120 may communicate with the database 110 through the network and communicate with user device 1 or user PC 2 based on information stored in the database 110. The processor 120 may control a screen provided on a display unit of user device 1 or user PC 2 and provide an interface to user device 1 or user PC 2, during a transaction.

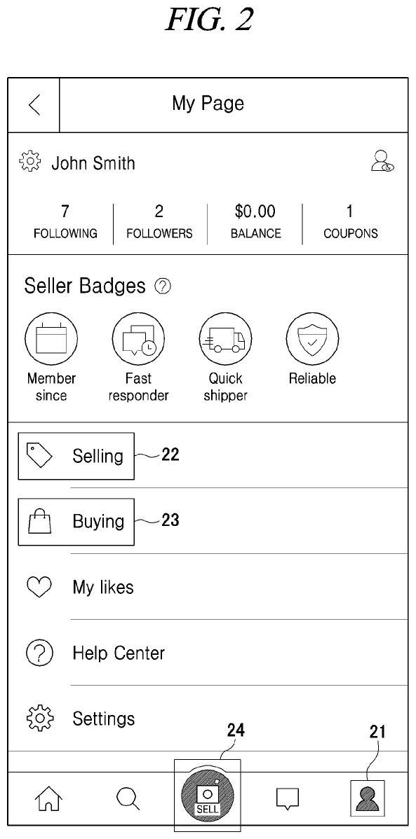

Hereafter, an example of screenshots provided on user device 1 by the processor 120 will be described with reference to FIG. 2 through FIG. 8.

FIG. 2 is an example screenshot on user device 1 using a mobile application for an online marketplace, in accordance with various embodiments described herein. The example screenshot may be displayed on user device 1 when a “My page” button 21 is selected on the mobile application for the online marketplace. The user may select a “Selling” button 22 to see a list of items sold through the user's account in the online marketplace. The user may also select a “Buying” button 23 to see a list of his/her purchased items.

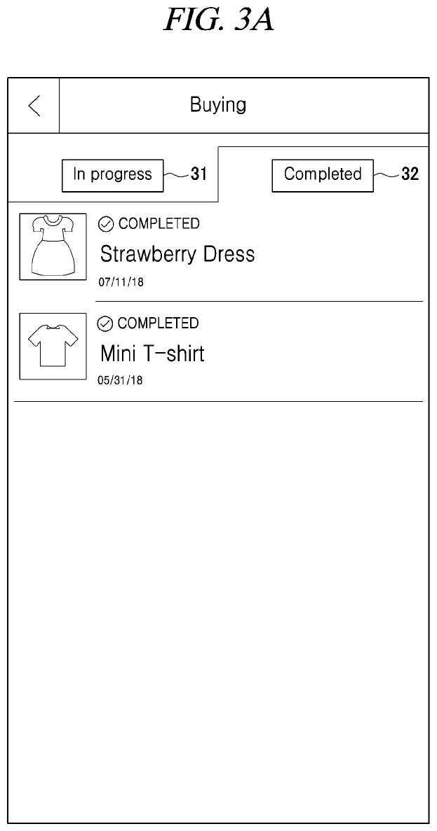

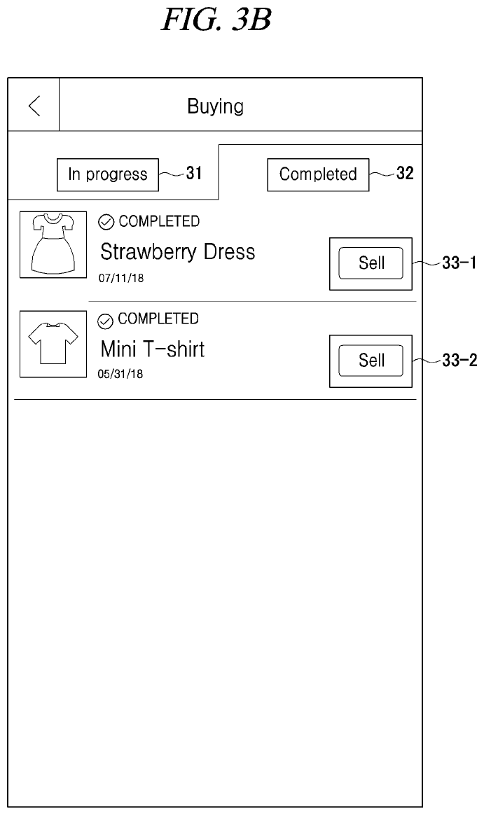

Referring to FIG. 3A, the user may select the “Buying” button 23 and then select a “Completed” button 32 to see a list of purchased items for which the transaction has been completed. The user may also select an “In progress” button 31 to receive a list of items for which the transaction is in progress. If the user wants to resell any previously purchased items, the user retrieves information about the item to be resold from the list of completely purchased items shown in FIG. 3A, returns to the screen shown in FIG. 2, and selects “Sell” button 24 to sell the item.

Various embodiments described herein facilitate efficient re-sale of items. Therefore, according to at least one embodiment described herein, if the user selects the “Buying” button 23 on the screen shown in FIG. 2, a screen corresponding to the example shown in FIG. 3B may then be displayed on user device 1.

Upon activating the “Buying” button 23, shown in FIG. 2, and then activating the “Completed” button 32, shown in FIG. 3A, a list of items for which the purchase has been completed (fully purchased items) may be displayed on user device 1, or the “In progress” button 31 may be activated to display a list of items for which the purchase remains in progress, as described above with reference to FIG. 3A. According to at least one embodiment described herein, the list of fully purchased items may be displayed upon activation of “Sell” buttons 33-1 and 33-2 shown in FIG. 3B. Therefore, if the user wants to resell at least one previously purchased items, the user may select a “Sell” button 33 corresponding to the item to be resold on the screen displaying the list of purchased items, in order to immediately sell the item (that is, offer the item for resale).

For example, if the user wants to resell the “Strawberry Dress,” shown in FIG. 3B, from the displayed list of purchased items, the user may activate the “Sell” button 33-1 corresponding to “Strawberry Dress” to sell that item. When the selection or activation of “Sell” button 33-1 is input, processor 120 may provide user device 1 with a user interface that enables the user to input information about the item.

According to at least one embodiment described herein, processor 120 does not provide the “Sell” buttons 33-1 and 33-2 to the list of purchased items immediately after completing purchase of items, but instead displays the “Sell” buttons after a certain period of time, which is based on predetermined criteria, upon completion of the purchase of the items. For example, a screenshot corresponding to FIG. 3A may be provided immediately after completing purchase of items. However, after a certain period of time, a screenshot corresponding to FIG. 3B may be provided. Herein, the predetermined criteria may be relevant to category information of the items. The processor 120 may determine certain criteria depending on category information of items and determine the time to display the “Sell” buttons 33-1 and 33-2 based on the determined criteria.

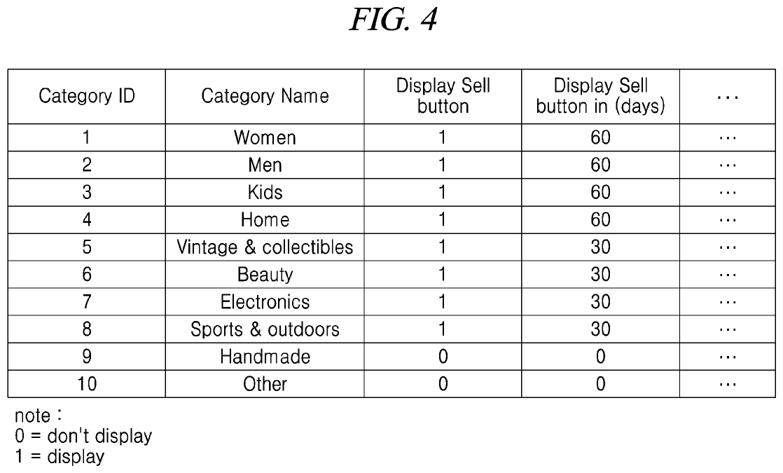

FIG. 4 shows a table to illustrate examples of when a “Sell” button may be displayed at different points in time depending on category information, in accordance with various embodiments described herein. For example, as shown in the example of FIG. 4, items traded in the online marketplace may be categorized into ten (10) groups including, as non-limiting examples, “Women”, “Men”, “Kids”, “Home”, “Vintage & collectibles”, “Beauty”, “Electronics”, “Sports & outdoors”, “Handmade”, and “Other” as shown in the table of FIG. 4.

As described above, processor 120 may determine the time to display a “Sell” button depending on category information. Referring to FIG. 4, for example, if an item is placed in the “Women” category, processor 120 may provide a “Sell” button after 60 days from the purchase of the item. As another example, if an item is placed in the “Electronics” category, processor 120 may provide a “Sell” button after 30 days from the purchase of the item. That is, processor 120 may have different criteria for determining the time to display the “Sell” button for different items, depending on the corresponding category. For instance, the time to display a “Sell” button may be calculated, by processor 120, according to an appropriate calculation algorithm selected based on a re-sale success rate, a period of usage of an item, and the like.

Further, according to at least one embodiment described herein, processor 120 may never display a “Sell” button for an item belonging to a specific category. For example, as shown in FIG. 4, for items categorized as being “Handmade” and “Other”, respectively, the processor 120 might not ever display “Sell” buttons for the respective items because such items cannot be resold for legal reasons, logistical reasons, user history, etc.

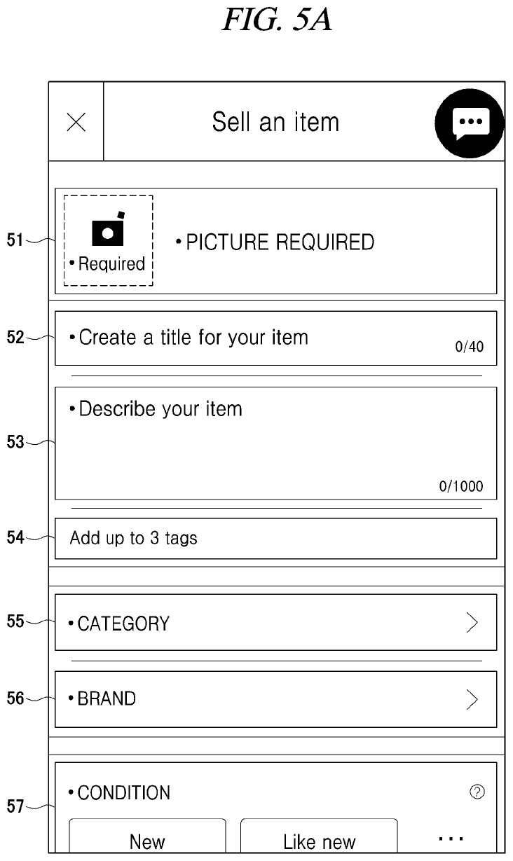

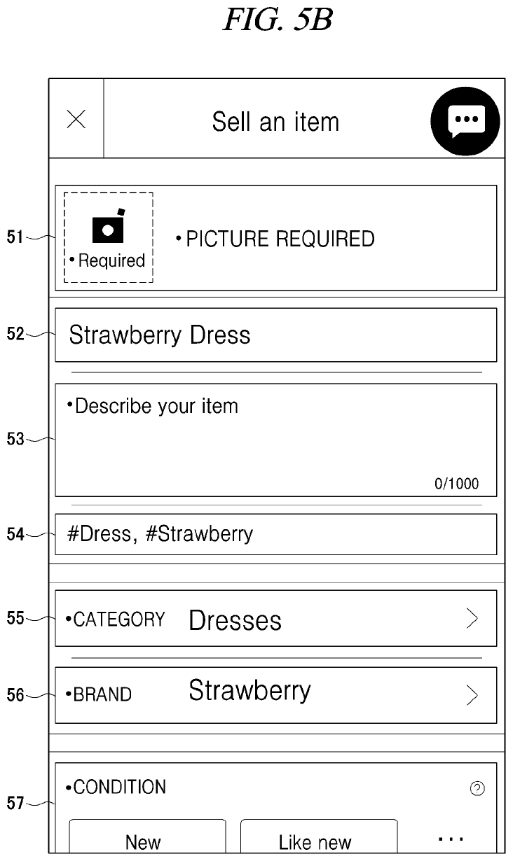

FIG. 5A is an example screenshot of a user interface provided on user device 1 that may appear when selling an item through the online marketplace, in accordance with various embodiments described herein (for example, when the user selects the “Sell” button 24 on the screen shown in FIG. 2 or when the user selects the ““Sell” buttons 33-1 and 33-2 on the screen shown in FIG. 3B). The user interface includes multiple input fields that may enable the user to input information about the item. For example, referring to FIG. 5A, the user interface may include a picture input field 51, a name input field 52, a description input field 53, a hashtag input field 54, a category input field 55, a brand input field 56, and a condition input field 57. The user inputs information about the item in each of the multiple input fields to sell the item.

The present disclosure is provided to reduce such inconvenience. According to at least one embodiment described herein, processor 120 may provide a user interface of which at least some of the multiple input fields are suggested by the processor 120. In one example, the at least some of the multiple input fields may be provided to be selectable from among one or more inputs suggested by the processor 120. In another example, at least some of the multiple input fields may be pre-filled by the processor 120. Processor 120 may fill in at least some of the multiple input fields before the re-sale using the purchase history information stored in the database 110. Thus, for example, a screen shown in FIG. 5B may be displayed. The user interface includes the multiple input fields in which the user typically fills with the requested pictures, name, description, hashtag, category, brand, and condition of the item. However, according to various embodiments described herein, the name, category, brand, and hashtag, as non-limiting examples, may pre-filled as illustrated in FIG. 5B, in which the name input field 52, the hashtag input field 54, the category input field 55, the brand input field 56 are pre-filled.

More particularly, the item name, category, brand, size, and hashtag are invariable information. Therefore, the apparatus 100, according to at least one embodiment described herein, may store information about an item input by a previous seller in the database 110; and if the user resells the item, apparatus 100 may copy information about the item stored in the database 110 to pre-fill a user interface with some, e.g., invariable, information about the item. Accordingly, it is possible to reduce the user's need to input all of information about a previously purchased item when reselling the item.

However, in the depiction of FIG. 5B, the picture input field 51, the description input field 53, and the condition input field 57 are not pre-filled but are, instead, to be filled in directly by the user. Pictures and description of the item may be copyrighted by a previous seller. Further, the condition of the item is likely different from the condition at the time of purchase by the previous seller. Therefore, the processor 120, according to at least one embodiment described herein, provides a user interface in which pictures, description, and condition of the item are not yet filled.

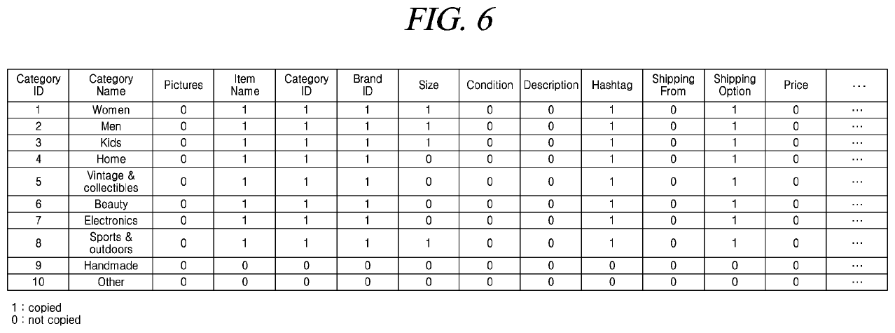

As described above, processor 120 may provide the user interface which enables the user to input information about the item and of which at least one of the multiple input fields is pre-filled, copies the information stored in the database 110, and then provides the information on the user interface. FIG. 6 shows a table to explain an example of data to be copied and filled beforehand and an example of data not to be copied.

FIG. 6 shows a table to illustrate examples of data input into a user interface, in accordance with various embodiments described herein. The table includes information such as the item name, category, brand, hashtag, and shipping option in Category ID Nos. 1 through 8, and is copied from the database 110 and filled in the user interface before the re-sale of a respective item. Size information for items in in Category ID Nos. 4 through 7 such as “Home”, “Vintage & collectibles”, etc. is not copied, since size information is not present for items in these categories even at the time of the original purchase.

Meanwhile, information and data such as pictures, condition, description, shipping from, and current price in all the categories are not copied because such information and data may be variable or may be copyrighted by a previous seller, as described above. For example, all of the information included in categories “Handmade” and “Other” is not copied because items belonging to certain categories may not be resold, as described previously.

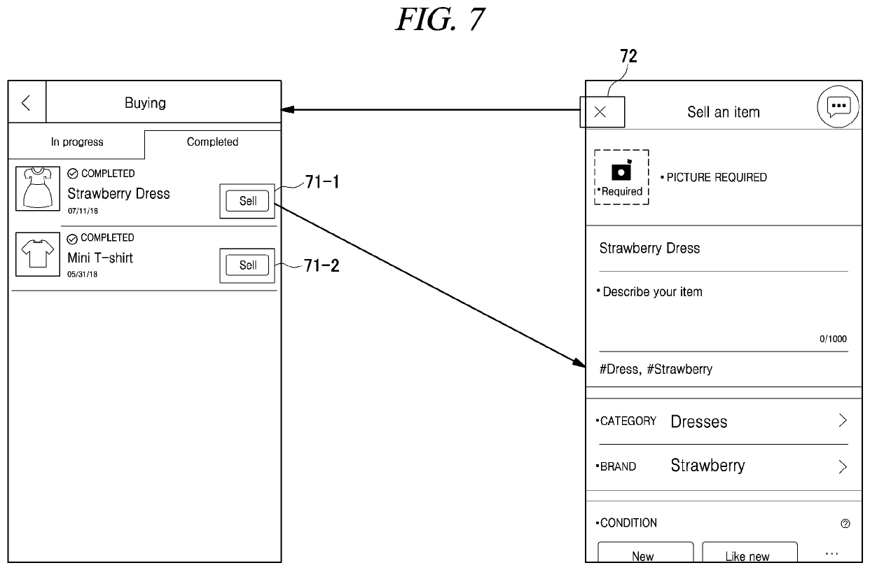

FIG. 7 shows screenshots to illustrate an example data flow between respective screens on, e.g., user device 1, in accordance with various embodiments described herein. User device 1 may receive, from processor 120, a list of items purchased to be displayed on the left screen depiction of FIG. 7, as well as “Sell” buttons 71-1 and 71-2 corresponding to the respective items. If the user wants to resell an item “Strawberry Dress,” the user may select “Sell” button 71-1 beside “Strawberry Dress” to display the user interface shown on the right screen depiction of FIG. 7. As shown on the right screen depiction in FIG. 7, user device 1 may receive the user interface in which at least some of information about the item is pre-filled. By activating or selecting “X” button 72 at the top left corner on the right screen depiction in FIG. 7, the display on user device 1 returns to the screen displaying the list of the purchased items as shown on the left screen depiction of FIG. 7.

If user device 1 receives the user interface in which at least some information about the item is pre-filled and receives user input to complete the other information about the item (pictures, description, and condition of the item), the processor 120 may post the input information in the online marketplace for viewing by other users.

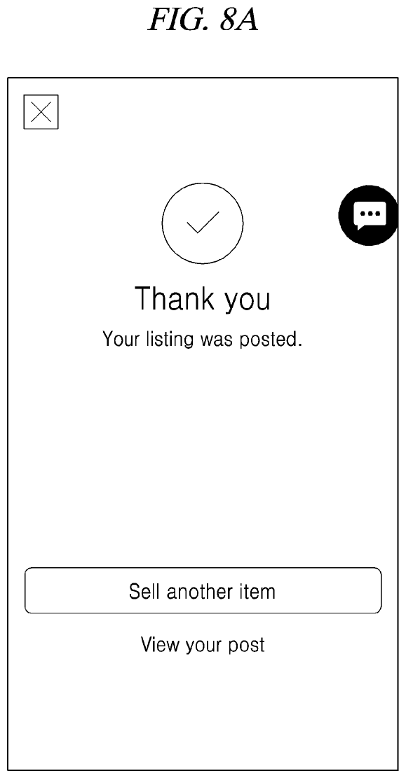

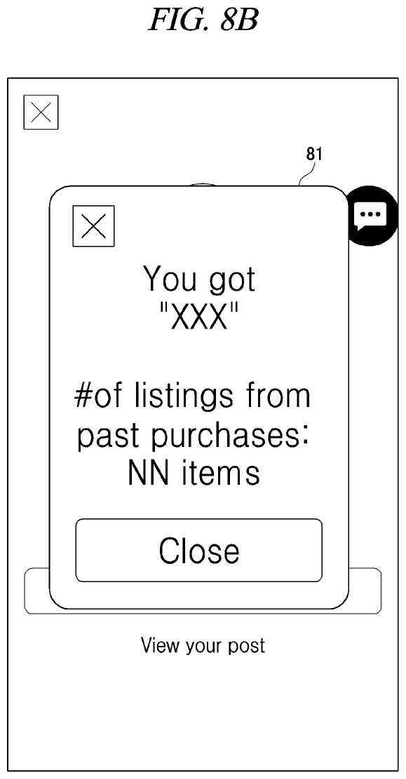

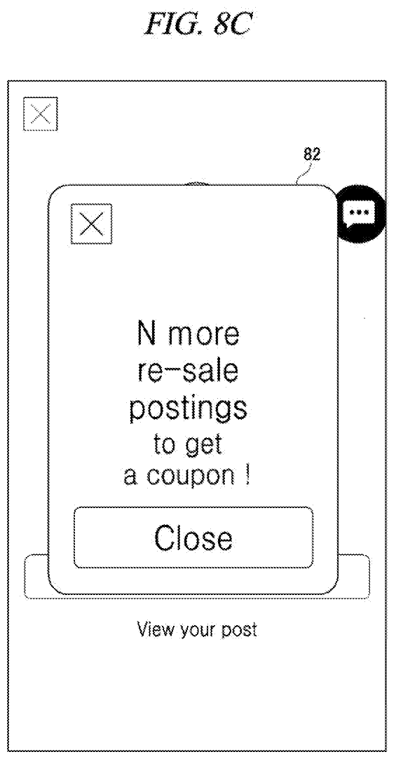

FIG. 8A is an example screenshot on a user device show upon a re-sale posting in the online marketplace, in accordance with various embodiments described herein. If another user of the online marketplace purchases the item through the re-sale posting, the re-sale of the item is completed.

The apparatus 100 for supporting the re-sale of an item according to various embodiments described herein offers an incentive to a user who completes a predetermined number of product or item re-sales in order to energize the online marketplace system. To this end, the processor 120 may count the number of re-sale postings referring to the number of times information of an item included in a list of purchased items is posted to be resold. The processor 120 may count the number of re-sale postings only once for each item. Thus, even if the user repeatedly posts the re-sale information for the same item several times, the processor 120 may count once for the same item. Alternatively, the processor 120 may count the number of re-sales referring to the number of times an item included in a list of purchased items is resold, and may inform the user of the number of times of completed re-sales. Further, if the processor 120 offers an incentive to the user when he/she has resold the item and/or completed the re-sale posting of the item a predetermined number of times, the processor 120 may pop up a notice window 81 on the screen of user device 1 as shown in FIG. 8B.

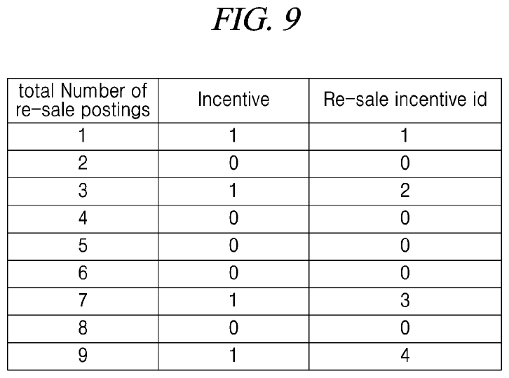

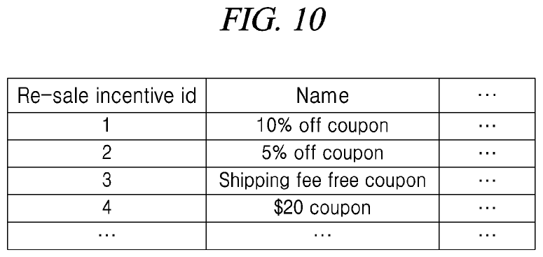

FIG. 9 and FIG. 10 show tables to illustrate examples of when an incentive is offered based on a number of re-sales reaching a predetermined number. The processor 120 may count the number of re-sale postings and/or re-sales by the user, and offer an incentive to the user when the number reaches a predetermined number. For example, referring to FIG. 9, when the number of re-sale postings and/or re-sales reaches 1, 3, 7, or 9, the processor 120 may offer an incentive to the user. Otherwise, as shown in FIG. 10, whenever the number of times of re-sale reaches 1, 3, 7, or 9, the processor 120 may offer various coupons to the user.

Before the number of re-sale postings and/or re-sales reaches a predetermined number in order to offer an incentive, processor 120 may display a pop-up window on user device 1 to notify the user that an incentive will be offered soon. FIG. 8C is an illustration of an example of a screen on which a notice window 82 notifying the user of an upcoming incentive pops up, in accordance with various embodiments described herein. For example, if an incentive is offered when the number of times of re-sale postings and/or re-sale reaches 1, 3, 7 or 9 as shown in FIG. 9 and FIG. 10, when the number of times of re-sale postings and/or re-sale is 5, the processor 120 may cause the display of a window saying “2 more sales to get a coupon!”. A method for notifying or pre-notifying the user of an incentive is not limited to the method using a pop-up window as shown in FIG. 8B and FIG. 8C. Processor 120 may notify or pre-notify the user of an incentive by various methods such as sending an email, vibrating the user device 1, and the like.

As described above, processor 120 may provide the user with the user interface that enables the user to input information about an item to be sold (see FIG. 4B) and post the information pre-filled in the user interface and the information newly input by the user in the online marketplace.

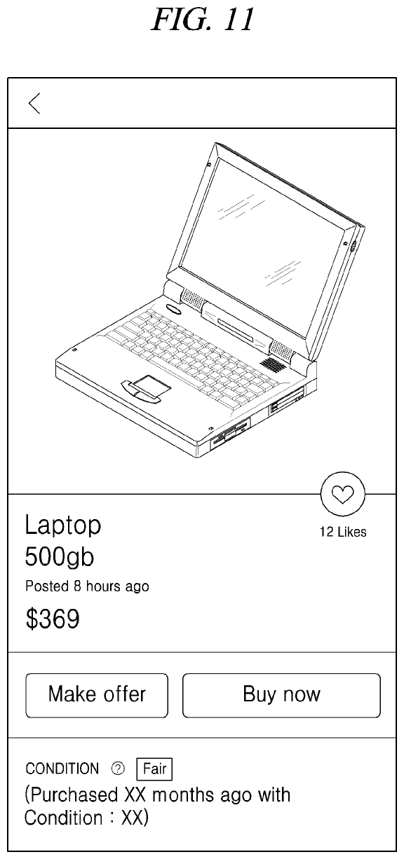

FIG. 11 is an example of posted item information, in accordance with various embodiments described herein. Other users of the online marketplace, i.e., those interested in making a purchase may be shown a screen as shown in FIG. 11 to check the posted item information. Those interested in making a purchase may check information about the item, such as pictures of the item, name, brand, and the like, from the screen.

Further, according to at least one embodiment described herein, the purchase history information stored in the database 110 may include the date of purchase of the item by the user and the condition of the item at the time of the purchase. The processor 120 may post the date of purchase of the item by the user together with the condition of the item at the time of the purchase. Thus, those interested in making a purchase may learn “when” and in “what condition” the user purchased the item. For example, those interested in purchase may be provided with information such as “Purchased XX months ago with Condition: XX” as shown on the screen of FIG. 11. As such, the system guarantees status information about items and thus can further promote the re-sale of items.

In the online marketplace where the trading of second-hand items has been brisk, the same item may be traded many times through the same online marketplace system. That is, a user may sell an item to another user and another user may sell the item to yet another user. In this way, the same item may be traded many times between multiple users of the system. If an item has been traded through the system before the user purchases the item, the processor 120 may track sale history of the item. Therefore, according to at least one embodiment described herein, the database 110 may store a history of at least one sale of an item before the purchase of the item by the user and a price history thereof.

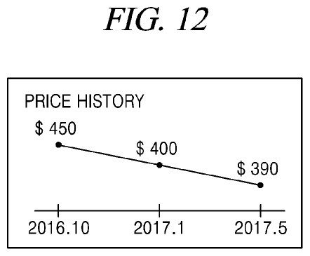

The sale and price history of the item may be posted for those interested in making a purchase. That is, according to at least one embodiment described herein, the processor 120 may provide a history of previous sales of an item together with a price history thereof when posting the information. Further, according to at least one embodiment described herein, a history of at least one time of previous sale and a price history may be provided in the form of a graph in order for those interested in purchase to easily understand. For example, a graph shown in FIG. 12 may be added to the screen shown in FIG. 11.

The graph shown in FIG. 12 may help those interested in purchase easily understand when and at what price the posted item has been sold. However, the sale and price history may be provided in any other form such as a table or text instead of the graph shown in FIG. 12.

Hereafter, a method for supporting the re-sale of an item according to at least one embodiment described herein will be described. The method according to at least one embodiment described herein may be performed by a controller according to a series of instructions stored in a computer-readable storage medium. Further, the method may be implemented on a computer.

The method according to at least one embodiment described herein includes providing a list of items purchased from the online marketplace and a “Sell” button corresponding to each of the items and providing a user interface that enables the user to input information about the purchased items when the “Sell” button is selected.

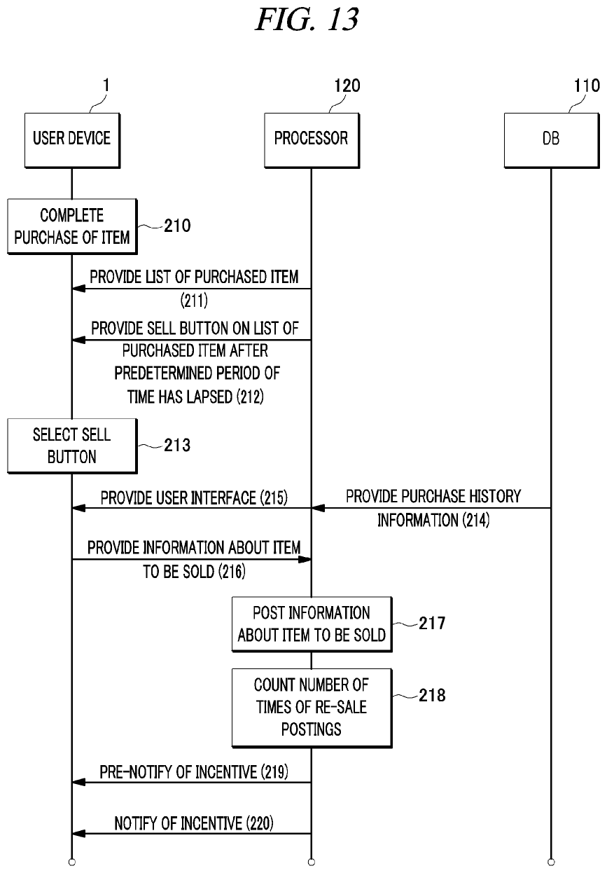

Hereafter, the method for supporting the re-sale of an item according to at least one embodiment described herein will be described in detail with reference to FIG. 13, which is an example processing flow for supporting the re-sale of items implemented by user device 1, processor 120, and the database 110 of apparatus 100. The method according to at least one embodiment described herein may be implemented by the user PC 2 instead of the user device 1.

As shown in FIG. 13, when the purchase of items from the online marketplace is completed by the user device 1 (S210), processor 120 may provide a list of the items purchased by the user of the user device 1 (S211). In this case, “Sell” buttons are not provided. Processor 120 may determine whether a predetermined period of time has lapsed after the purchase of items. If it is determined that the predetermined period of time has lapsed, processor 120 may provide “Sell” buttons on the list of the purchased items (S212). As described above, the time to display a “Sell” button may be determined depending on the category for a particular item.

If a request to sell is input through a “Sell” button (S213), processor 120 may provide the user device 1 with a user interface that enables the user to input information about the item (S215). As described above, the user interface may include multiple input fields that enable the user to input various information about the item, and at least one of the multiple input fields may suggested based on the type of information regarding the item. To provide the user interface of which at least one input field is suggested, processor 120 may receive a sale history stored in the database 110 (S214).

If the user completely inputs the other information about the item in addition to the item information suggested in the user interface, the user device 1 provides processor 120 with information about the item to be sold (S216). Processor 120 may post the information about the item for other users of the online marketplace, i.e., those interested in making a purchase (S217). Those interested in making a purchase of the item may check the posted item information and purchase the item. If one of those interested in making a purchase completes the purchase of the item, the re-sale of the item by the user is completed. In this way, the user may re-sell each item in the list of the purchased items to other users of the online marketplace.

If the re-sale posting of the item is completed, processor 120 may count the total number of times of re-sale postings, which refers to the number of times the item in the list of the purchased items is resold (S218). Whenever the number of times of re-sale postings reaches a predetermined number of times, the processor 120 may offer an incentive. The processor 120 determines whether the number of times of re-sale postings has reached the predetermined number in order to offer an incentive. If it is determined that the number of re-sale postings has reached the predetermined number, processor 120 may offer an incentive to the user (S220). For example, if the predetermine number is 1 or 3, when the number of times of re-sale postings is 1 or 3, processor 120 offers an incentive to the user. However, if the number of times of re-sale postings does not reach the predetermined number, processor 120 does not offer an incentive to the user, but pre-notifies the user of the incentive (S219). For example, if the predetermined number of times is 1 or 3, when the number of times of re-sale postings is 2, processor 120 may pre-notify the user that an incentive will be offered when one more re-sale is completed.

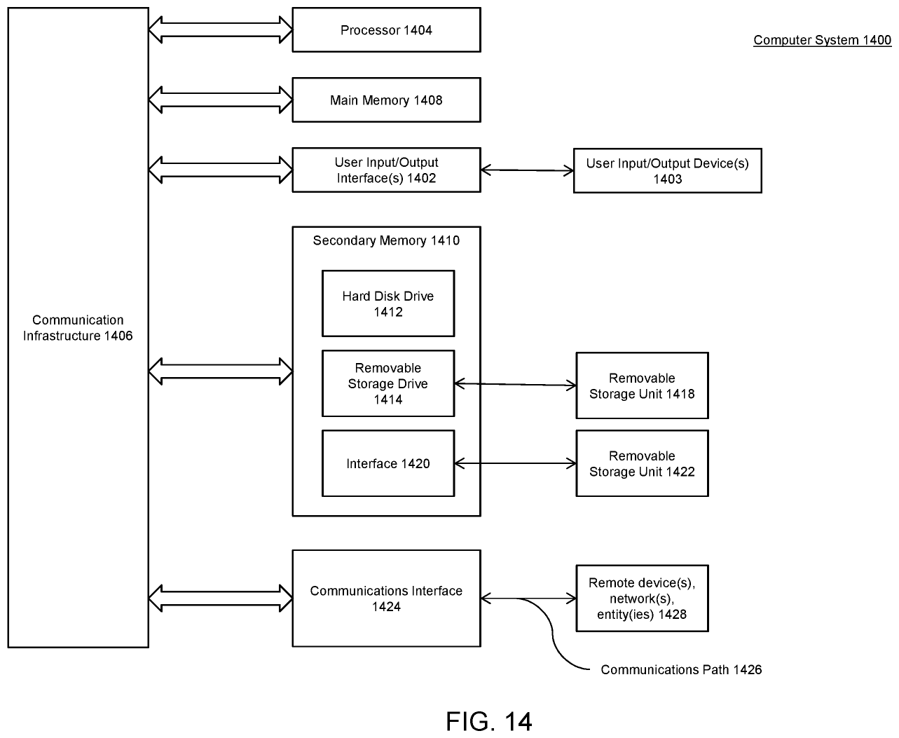

Various embodiments may be implemented, for example, using one or more well-known computer systems, such as computer system 1400 shown in FIG. 14. One or more computer systems 1400 may be used, for example, to implement any of the embodiments discussed herein, as well as combinations and sub-combinations thereof.

Computer system 1400 may include one or more processors (also called central processing units, or CPUs), such as a processor 1404. Processor 1404 may be connected to a communication infrastructure or bus 1406.

Computer system 1400 may also include user input/output device(s) 1403, such as monitors, keyboards, pointing devices, etc., which may communicate with communication infrastructure 1406 through user input/output interface(s) 1402.

One or more of processors 1404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1400 may also include a main or primary memory 1408, such as random access memory (RAM). Main memory 1408 may include one or more levels of cache. Main memory 1408 may have stored therein control logic (i.e., computer software) and/or data.

Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, a magnetic tape drive, a compact disk drive, an optical storage device, tape backup device, and/or any other storage device/drive.

Removable storage drive 1414 may interact with a removable storage unit 1418. Removable storage unit 1418 may include a computer usable or readable storage device having stored thereon computer software (control logic) and/or data. Removable storage unit 1418 may be a floppy disk, magnetic tape, compact disk, DVD, optical storage disk, and/any other computer data storage device. Removable storage drive 1414 may read from and/or write to removable storage unit 1418.

Secondary memory 1410 may include other means, devices, components, instrumentalities or other approaches for allowing computer programs and/or other instructions and/or data to be accessed by computer system 1400. Such means, devices, components, instrumentalities or other approaches may include, for example, a removable storage unit 1422 and an interface 1420. Examples of the removable storage unit 1422 and the interface 1420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1400 may further include a communication or network interface 1424. Communication interface 1424 may enable computer system 1400 to communicate and interact with any combination of external devices, external networks, external entities, etc. (individually and collectively referenced by reference number 1428). For example, communication interface 1424 may allow computer system 1400 to communicate with external or remote devices 1428 over communications path 1426, which may be wired and/or wireless (or a combination thereof), and which may include any combination of LANs, WANs, the Internet, etc. Control logic and/or data may be transmitted to and from computer system 1400 via communication path 1426.

Computer system 1400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1400, main memory 1408, secondary memory 1410, and removable storage units 1418 and 1422, as well as tangible articles of manufacture embodying any combination of the foregoing. Such control logic, when executed by one or more data processing devices (such as computer system 1400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 14. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner. The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A data processing apparatus for managing a re-sale of an item, comprising:
a database that stores purchase history information of an item purchased from an online marketplace; and
a processor that causes a user device to display a list of at least one purchased item and a selectable re-sell button to re-sell each purchased item, wherein the processor is configured to:
provide the selectable re-sell button after a certain period of time, based on predetermined criteria, from time of a purchase of the corresponding item, and
upon the selectable re-sell button being selected, provide the user device with a user interface to input information about the purchased item,
wherein the user interface includes multiple input fields of which at least one of the multiple input fields is suggested by the processor based on the purchase history information stored in the database.

2. The data processing apparatus of claim 1, wherein the purchase history information includes a category for the item and the predetermined criteria are relevant to the category.

3. The data processing apparatus of claim 1, wherein the purchase history information includes at least one of a name, category, brand, size, hashtag, or shipping charge information for the item.

4. The data processing apparatus of claim 1, wherein the purchase history information includes a date of purchase of the item and condition of the item at the time of the purchase.

5. The data processing apparatus of claim 4, wherein the processor is further configured to post the information input into the user interface on the online marketplace, wherein the information includes the date of purchase and the condition of the item at the time of the purchase when posting the information.

6. The data processing apparatus of claim 1, wherein the purchase history information includes a history of at least one time of previous sale of the item and a price history thereof.

7. The data processing apparatus of claim 6, wherein the processor is further configured to post the information input into the user interface on the online marketplace and provide the history of at least one time of previous sale of the item and the price history thereof when posting the information.

8. The data processing apparatus of claim 7, wherein the processor is further configured to provide a history of previous sales of the item and a price history thereof in the form of a graph.

9. The data processing apparatus of claim 1, wherein the processor is further configured to count the number of re-sale postings of the at least one purchased item.

10. The data processing apparatus of claim 9, wherein upon the number of re-sale postings reaching a predetermined number, the processor is further configured to cause the display of an incentive available on the online marketplace to the user device.

11. The data processing apparatus of claim 10, wherein upon a determination that the number of re-sale postings do not reach the predetermined number, the processor is further configured to calculate a difference between the number of times of re-sale postings and the predetermined number of times, and provide the user device with a notice of the difference.

12. A method to be implemented on a computer, comprising:
causing the display of a list of items purchased from an online marketplace;
determining whether a predetermined amount of time has lapsed since the purchase of the items;
causing the display of a selectable re-sell button for each purchased item upon a determination that the predetermined amount of time has lapsed; and
causing the display of a user interface to input information regarding the purchased item when the re-sell button is selected,
wherein the user interface includes multiple input fields and at least one of the multiple input fields is suggested based on the purchase history information.
